(19) United States
(12) Patent Application Publication
(10) Pub. No.: US 2015/0362734 A1
(43) Pub. Date: Dec. 17, 2015

(54) TRANSFLECTIVE HOLOGRAPHIC FILM FOR HEAD WORN DISPLAY

(71) Applicant: ECOLE POLYTECHNIQUE FEDERALE DE LAUSANNE (EPFL), Lausanne (CH)

(72) Inventors: Christophe MOSER, Lausanne (CH); Juergen BRUGGER, Vufflens-La-Ville (CH); Victor CADARSO, Renens (CH); Jonas GROSSENBACHER, Cressier (CH); Mickael GUILLAUMÉE, Neuchâtel (CH); Eric TREMBLAY, St. Sulpice (CH)

(21) Appl. No.: 14/763,703

(22) PCT Filed: Jan. 23, 2014
(86) PCT No.: PCT/IB2014/058487

§ 371 Date: Jul. 27, 2015

(30) Foreign Application Priority Data
Jan. 28, 2013 (IB) PCT IB2013/050725

(51) Int. Cl. G02B 27/01; G03H 1/18; G03H 1/02; G03H 1/04; G02B 5/32; G02C 7/04

(52) U.S. Cl. CPC G02B 27/0172; G02B 5/32; G02C 7/044; G03H 1/0248; G03H 1/041; G03H 1/0252; G03H 1/181; G03H 1/0465; G02B 2027/0174; G03H 2001/0415; G03H 2001/0439; G03H 2001/0264

(57) ABSTRACT

A display panel assembly comprises a transflective holographic screen, i.e., a transparent screen that reflects light from a projection system, comprising at least a volume hologram, a first protective element and a second protective element, each arranged in contact with the volume hologram such that the volume hologram is sandwiched between the first protective element and the second protective element. The display panel assembly further comprises a projection system focusing an image on the volume hologram comprising at least projection optics, mounting means arranged to fixedly mount the projection system relatively to the transflective holographic screen. The volume hologram comprises a plurality of diffractive patterns disposed in sequence across the volume hologram, each of the plurality of diffractive patterns being configured to diffuse the light rays from the projection system in a determined direction corresponding to the specific diffractive pattern and oriented towards a position of an intended eye of a user wearing the display panel assembly.

### FIELD OF THE INVENTION

The present invention relates to augmented reality displays, in particular, those systems that give the possibility to superimpose virtual images to normal vision, i.e. see-through displays such as head-up displays (HUD's) found for example in the automotive industry or head worn displays (HWD's) placed near to the eye.

### BACKGROUND

The adoption of mobile devices such as PDA's and more recently smartphones for consumer use offers new possibilities to interact with our environment, to obtain instantaneous information and to connect with people. Next generation mobile devices are expected to provide information by displaying it in a different manner than the current hand portable display screen. Advances in projection display technologies are enabling near the eye displays, such as a pair of see through glasses.

See-through displays have been used for decades for defence applications. For example, jet fighter pilots have been using head mounted displays on the fighter helmets to provide navigational and other critical information to the pilot in his/her field of view. While projection technology is advancing, there is still currently a trade-off between field of view and footprint in see-through HWD. A wide field of view (>30-40 degrees) requires bulky optics. A field of view of the order of 120 degrees laterally and 60-70 degrees vertically would give the user the feeling of total immersion into the virtual world and thus vastly improving the range of applications in augmented reality. This current trade-off makes HWD's non-aesthetically pleasing for large field of views and non-appealing for everyday use. Thus, there is a need for a small footprint, aesthetically pleasing see-through HWD with a large field of view.

A way to obtain HWD's with both large field of view and small footprint is to integrate optical components within a contact lens. This particular contact lens for HWD is described by Sprague—METHOD AND APPARATUS TO PROCESS DISPLAY AND NON-DISPLAY INFORMATION, U.S. patent application Ser. No. 12/204,567, Pub. No. US 2012/0053030 A1. A small focusing lens is placed at the centre of the contact lens to assist the eye to focus on the screen. The small lens of the contact lens collimates the light diffracted by the screen prior to entering the HWD wearer's eye.

A key part of a contact lens based HWD system is a transflective screen that redirects each displayed pixels towards the eye, while providing undisturbed see-through vision. Sprague et al. described a method providing such a transflective screen with a buried microlens array (MLA)—BURRIED NUMERICAL APERTURE EXPANDER HAVING TRANSPARENT PROPERTIES, U.S. patent application Ser. No. 11/852,628, publication No. US 2009/0067057 A1. In this invention, an increase in display reflection efficiency inevitably induces a reduction in the display transmission and reversely. Contrary to Sprague's display screen, the screen presented in the current patent provides high diffraction efficiency (up to 100%) and high transparency to the ambient light (up to 95%) because the reflection bandpass of the holographic screen is small (˜15 nm) compared to the bandwidth of visible light (300 nm).

### SUMMARY OF THE INVENTION

In a first aspect the invention provides a display panel assembly comprising a transflective holographic screen, i.e., a transparent screen that reflects light from a projection system, comprising at least a volume hologram, a first protective element and a second protective element, each arranged in contact with the volume hologram such that the volume hologram is sandwiched between the first protective element and the second protective element. The display panel assembly further comprises a projection system focusing an image on the volume hologram comprising at least projection optics, mounting means arranged to fixedly mount the projection system relatively to the transflective holographic screen. The volume hologram comprises a plurality of diffractive patterns disposed in sequence across the volume hologram, each of the plurality of diffractive patterns being configured to diffuse the light rays from the projection system in a determined direction corresponding to the specific diffractive pattern and oriented towards a position of an intended eye of a user wearing the display panel assembly.

In a first preferred embodiment the display panel assembly is used as a Head-Up Display (HUD).

In a second preferred embodiment the display panel assembly is further arranged to be used as a near to the eye Head-Worn Display (HWD).

In a third preferred embodiment the display panel assembly further comprises a bi-focal contact lens comprising a centre part which is arranged relative to the transflective holographic screen to collimate the light diffracted by the volume hologram prior entering the intended eye of the user thereby enabling the intended eye of the user to focus onto the transflective holographic screen, and an outerpart, which surrounds the centre part and is intended to allow an image of a view through the transflective holographic screen to be seen.

In a fourth preferred embodiment the projection system is a scanner projection system that is used to display information on the transflective holographic screen.

In a second aspect the invention provides a method for fabricating the volume hologram of the inventive display panel assembly. The method comprises interfering a reference beam and an object light beam on the photosensitive holographic material, the light beams having similar wavelengths than the light used within the projection system of the display panel, by means of a recording holographic setup. The step of interfering comprises directing the reference beam to impinge on the photosensitive holographic material with the properties of the projection system, i.e., whereby the properties are indicative at which angle of incidence and with which numerical aperture the reference beam is projected on the photosensitive holographic material, and directing the object beam to impinge on an opposite side of the photosensitive holographic material as compared to the reference beam thereby producing a reflection hologram.

In a fifth preferred embodiment the method comprises providing the photosensitive holographic material as a film laminated onto a transparent substrate.

In a sixth preferred embodiment the method further comprises providing the photosensitive holographic material as a liquid photopolymer by coating any surface shape in contact with the photosensitive holographic material.

In a seventh preferred embodiment the method further comprises shaping the any surface in contact with the photosensitive holographic material according to one of the following list of shapes: flat, cylindrical, spherical.

In an eighth preferred embodiment the method further comprises recording the volume hologram either simultaneously or sequentially with several wavelengths to produce a colour screen.

In a ninth preferred embodiment the method further comprises transmitting the object beam through a structure that diffuses light within a given angular spread so that upon use, the then obtained volume hologram enabling the transflective holographic screen to direct the projected light toward the intended eye of the user within a certain angular spread.

In a tenth preferred embodiment the method further comprises providing for the structure that diffuses light a microlens array (MLA) whose lenses' numerical aperture defines an angular spread of each pixel and a pitch of the microlens array defines a minimum pixel size of the screen.

In an eleventh preferred embodiment of the inventive method, a fill factor of the microlens arrays (MLA) is larger than 90%.

In a twelfth preferred embodiment the method further comprises replicating the microlens array (MLA) on a curved surface with at least the following fabrication steps: replicating a negative replica of the microlens array (MLA) in, but not limited to, an elastomer, and dispensing a drop of, but not limited to, curable polymer on a concave side of the curved surface. The microlens array (MLA) negative replica acts as a mold and a flexibility of the elastomer enables the negative replica to conform to the curved surface. Further the fabrication steps comprise curing the polymer with a UV curing treatment, and removing the mold to release the microlens array (MLA) on a curved surface.

In a thirteenth preferred embodiment the method further comprises using a condenser lens in combination to the structure that diffuses light such that light is directed toward the intended eye of the user, thus increasing the field of view and tolerance to rotation of the eye.

### BRIEF DESCRIPTION OF THE DRAWINGS

The invention will be better understood in view of the description of preferred example embodiments and in reference to the figures, wherein

FIG. 1 is a schematic showing the basic principle of the see-through display;

FIG. 2 is a schematic of the holographic recording principle to fabricate the transflective screen;

FIG. 3 is a schematic of the optical properties of a condenser lens (203) and MLA (204) combination showing that each beamlet transmitted through each lenslet reaches the eye pupil entrance of the HWD user even when the eye rotates from FIG. 3A to FIG. 3B;

FIG. 4 is a schematic of the hologram readout;

FIG. 5 is a schematic showing the basic principle of the wide field of view HWD;

FIG. 6 shows the process flow of the MLA replication on a curved surface;

FIG. 7 is a schematic of a particular setup that can be used to record a holographic screen;

FIG. 8(a) shows an image of a setup to demonstrate the proof of concept of the wide angle see-through display with the holographic transflective screen;

FIG. 8 (b) and (c) are images of a contact lens taken under linearly polarized light for two different angle of rotation; and

FIG. 9 (a) and (b) show see-through image without and with virtual image respectively. (c) Same as (b) with see through vision partially blocked.

Same reference numbers will be used throughout the description to refer to the same or similar element(s).

### DETAILED DESCRIPTION

In the following paragraphs a more detailed description of selected figures is given.

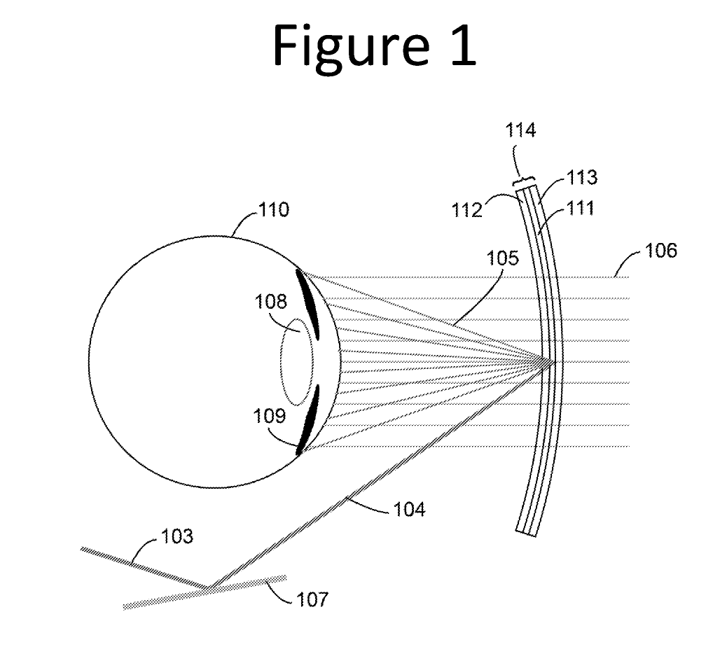

FIG. 1 is a schematic showing the basic principle of the see-through display. A volume hologram 111 sandwiched between transparent protective films 112 and 113 and constituting a transflective holographic screen 114 diffracts the incident light 104 projected from a system 107 toward the eye 110. Light 106 providing normal see-through vision is transmitted through the transflective screen 114. The light projected onto the transflective screen is diffracted toward the eye into light 105 within a certain angular spread.

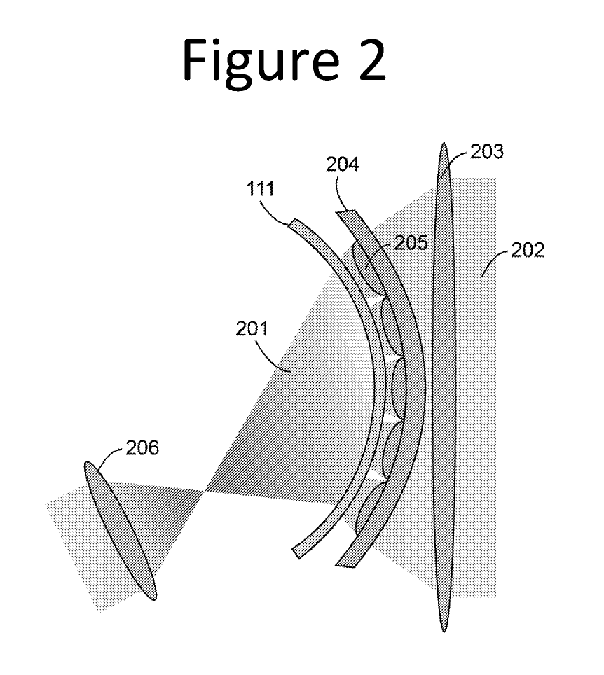

FIG. 2 is a schematic of the holographic recording principle to fabricate the transflective screen. A condenser lens 203 followed by an MLA 204 is placed in the object beam 202. Coherent light is split into a reference beam 201 and an object beam 202 that interfere at the volume hologram 111, thus modifying locally the refractive index of the volume hologram 111 and recording the waveform created by the MLA and condenser lens combination.

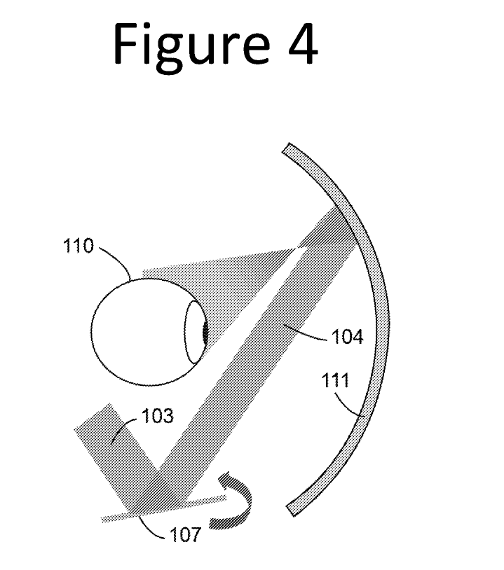

FIG. 4 is a schematic of the hologram readout. The beam 104 incident on the volume hologram 111 at the same angle and wavelength used to record the volume hologram 111 is diffracted toward the eye 110 within an angular spread given by the MLA used during recording.

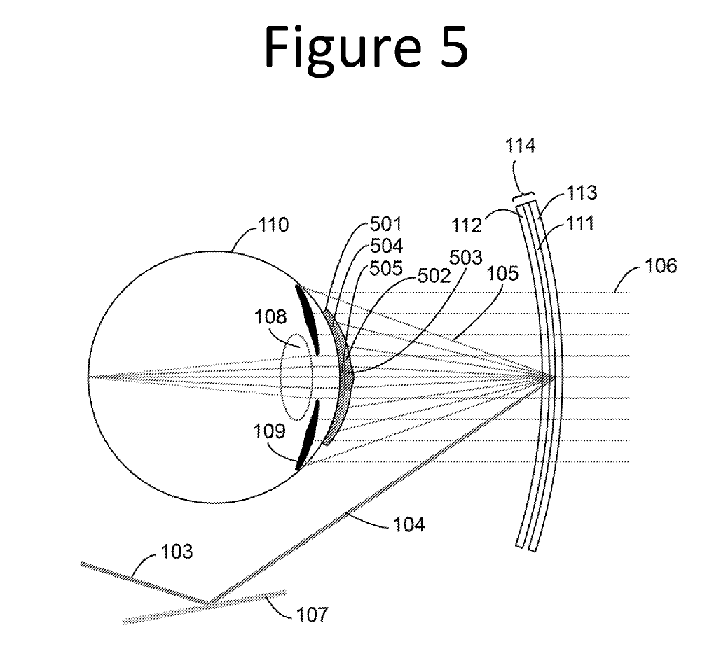

FIG. 5 is a schematic showing the basic principle of the wide field of view HWD. A bi-focal length contact lens 501 allows the eye 110 to simultaneously focus the image displayed on the spectacle surface and diffracted toward the eye by the transflective screen 111 and forming an image through the glasses (normal see-through vision). The light 104 projected onto the transflective screen 111 is diffracted toward the eye 110 within a certain angular spread.

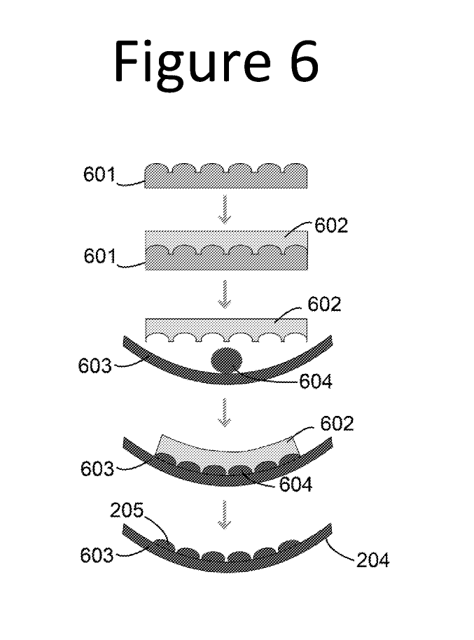

FIG. 6 shows the process flow of the MLA replication on a curved surface. Commercially available MLA's typically provided on flat substrates 601 are replicated in an elastomer 602. A drop of curable polymer 604 is placed on the concave side of the curved surface 603. The MLA negative replica 602 acts as a mold. The flexibility of the elastomer allows the negative replica 602 to conform to the curved surface 603. After UV curing, the mold 602 can be removed and an MLA 204 is present on the curved surface 603.

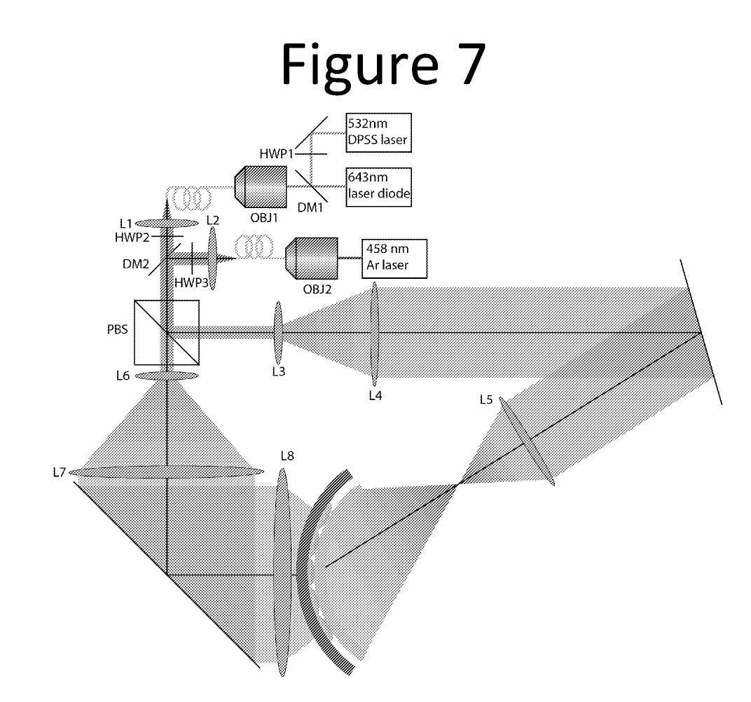

FIG. 7 is a schematic of a particular setup that can be used to record a holographic screen.

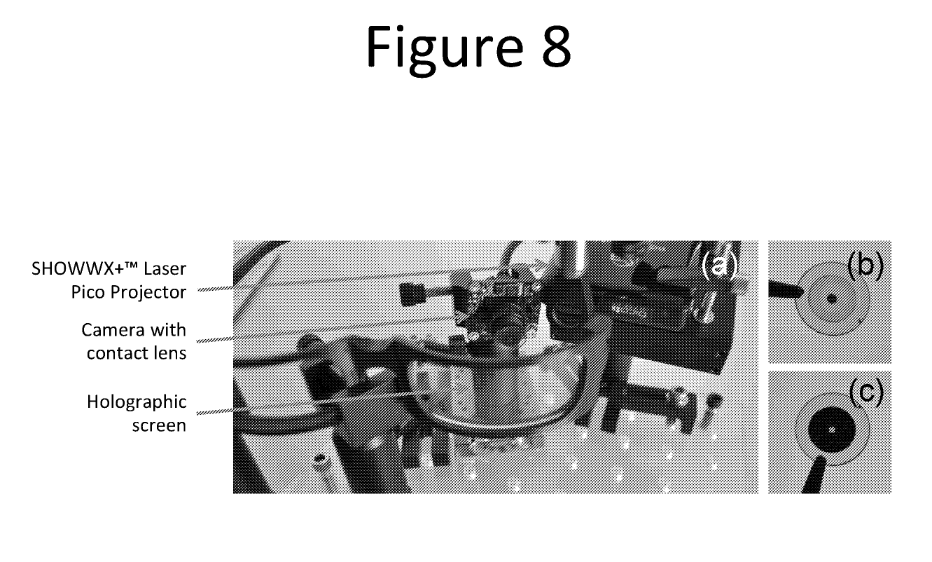

FIG. 8(a) shows an image of a setup to demonstrate the proof of concept of the wide-angle see-through display with the holographic transflective screen. A micro-projector together with a lens is used to project images on the holographic screen. A camera together with a camera lens is used as an artificial eye. A contact lens is placed on this artificial eye. Both light diffracted by the screen and transmitted through the screen is then focused onto the camera sensor.

The present invention is a system that uses a number of elements, the combination of which provides a large field of view see-through display. The elements comprise
1. a volume holographic optical element used as a “transflective” screen for see-through HWD's. The near to the eye screen allows light from the surrounding environment to be transmitted through the screen while light from a projection system impinges on the screen which manipulates light by diffraction to re-direct it toward the centre of the wearer's eye;
2. a scanning projection system that uses a micromirror to scan a near collimated output to form an image by raster scanning; and
3. a bi-focal contact lens whose centre part (focal 1) forms an image of the spectacle glass placed near the eye and whose outerpart (focal 2) forms an image of the through-view.

The present invention is not limited to HWD's. The transflective screen can also be used in HUD's, i.e. in systems which do not need the display to be placed near the eye, and consequently which do not need a bi-focal contact lens.

In at least one embodiment, the transflective screen could be fabricated by use of a reflective holographic technique. In at least one embodiment, the fabrication of the holographic screen is obtained from a recording holographic setup where two coherent beams of similar intensity interfere. One of the two beams of the recording holographic setup, called reference beam, should impinge on the holographic material with the properties of the HWD projection system, i.e. at which angle of incidence and numerical aperture light is projected on the screen. The second beam, called object beam, should impinge on the opposite side of the holographic material as compared to the reference beam so that to produce a reflection hologram.

In yet another embodiment, the object beam should be transmitted through a structure that diffuses light within a given angular spread so that upon use, the then obtained transflective screen directs the projected light toward the wearer eye within a certain angular spread. In another embodiment, a condenser lens could be used in combination to the diffusing structure such that light is directed toward the eye, thus increasing the field of view and tolerance to rotation of the eye. In another embodiment, the diffusing structure consists of a microlens array (MLA) whose lenses numerical aperture defines the angular spread of each pixel and the pitch or the array defines the minimum pixel size of the screen. The fill factor of the MLA should be as high as possible in order to have good display homogeneity and low diffraction upon watching at a bright scene. The fill factor should be larger than 90%.

A bi-focal contact lens placed on the eye of the HWD user allows light diffracted by the transflective screen to be collimated prior to entering the wearer's eye. The user eye focuses then the light coming from the display onto the wearer's retina thus mimicking an image coming from infinity. Light from the surrounding environment remains unperturbed by the contact lens, thus allowing images from both the display and the wearer's surrounding environment to superimpose.

In yet another embodiment, the transflective screen could be fabricated by any technique allowing structures similar to the ones obtained by the holographic technique to be reproduced.

The techniques, apparatus, materials and systems as described in this specification can be used to fabricate a transflective screen.

Described is a transflective screen to be used, but not limited to, close to the eye in HWD systems. Such transflective screen could be similarly used in other devices such as Head-Up Displays like those used in the automobile industry. Light from the environment is largely transmitted through the screen whereas light emitted from the projection system of the HWD is directed toward the human visual system. The described invention leads to a large displayed field of view together with a small footprint of the device.

The screen principle is illustrated in FIG. 1. A collimated light beam 103 is incident on a projection system consisting of a 2-dimensional scanning mirror 107 and projection optics (not shown) to produce an exiting light ray 104, which is focused on a holographic film 111. Protective elements 112 and 113 sandwich the film 111. The film 111 produces a diffracted cone beam 105 whose chief ray is diffracted toward the eye. The protective elements 112, 113 and the film 111 form the transflective holographic screen 114. In at least one embodiment, information consists of scanned points which form an image on the film 111 which in turn diffracts every said points to form a light beam of a certain angular spread such that any illuminated portion of the film 111 can be seen for a given rotation range of eye 110. The pupil 109 stops part of the light cone 105 and part of it is transmitted through the crystalline lens 108. The screen plays the role of a light combiner as well as an eye pupil expander. Light 106 from the outside environment remains essentially undistorted after being transmitted through the screen.

The present invention suggests fabricating such a screen by means of a holographic technique, more precisely by fabricating a reflection hologram. A reflection hologram is fabricated by interfering two coherent light sources located on both sides of a holographic film, as illustrated in FIG. 2. In the present case, one beam called reference beam 201 possesses comparable wavelengths, angle of incidence and numerical aperture as the projection system 107 that can be for example, but not limited to, mounted on the side of the eyewear. The second beam called objet beam 202 determines how the screen diffracts incident light.

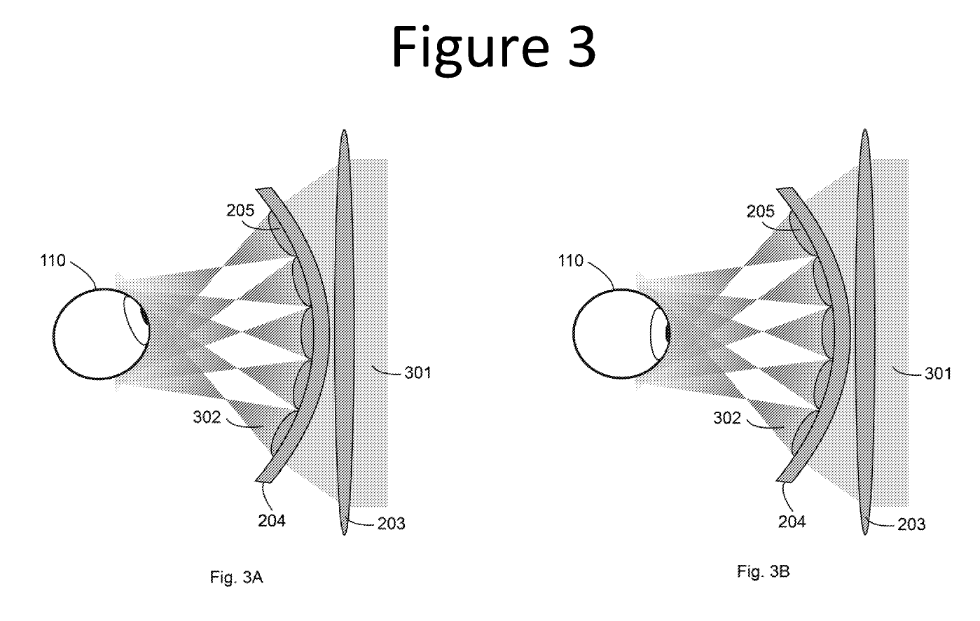

In at least one embodiment illustrated by FIG. 2, an MLA 204 containing individual lenslets 205 together with a condenser lens 203 is used in the object beam of the holographic fabrication setup to tailor the screen diffraction properties. The role of the condenser lens 203 is to redirect light from each point on the screen toward the eye pupil entrance. The condenser lens 203 is placed in close proximity to the holographic film 111 such that the focal point of the condenser lens corresponds to the position of the centre of rotation of the user's eye in the HWD. Each lenslet 205 of the MLA 204 can be considered the equivalent of a transflective screen pixel, which diffuses light over a solid angle determined by the numerical aperture of the lenslets. As illustrated in FIG. 3 where the eye is rotated from FIG. 3(a) to FIG. 3(b), the light from every lenslet 205 enters the pupil of the eye 110 for any eye rotation within a range governed by the lenslet numerical aperture.

As the reflection hologram records the optical properties of the MLA 204, each area on the film 111 is observable for any eye rotation within a range governed by the lenslet 205 numerical aperture.

The optical characteristics of the holographic film fabricated according to the description above are illustrated in FIG. 4. A collimated beam 103 is deflected in two dimensions by a micromirror 107 producing a collimated beam 104 that is focused on the holographic film 111 at similar angle, numerical aperture and wavelength as the beam 201 used in the recording setup. Beam 104 is diffracted by the film 111 producing a cone beam directed toward the eye 110 as if the beam is coming from the object beam 202 (not shown in FIG. 4). Such a configuration provides a display with a wide field of view given by the combination of the numerical aperture of the lenslets 205 and the direction of the chief-rays from each lenslets converging to the centre of the eye 110.

In the case where the screen 114 is placed too close to the eye 110, it is not possible or rather effort demanding to focus on the screen. In at least one embodiment, the HWD user can focus on the near-to-the-eye screen with the help of a special contact lens 501 illustrated in FIG. 5. A small focusing lens 503 is placed at the centre of the contact lens 501 to assist the eye 110 to focus on the screen 114. The small lens 503 of the contact lens 501 collimates the light 105 diffracted by the screen 114 prior to entering the HWD wearer's eye 110.

A band pass filter 505 is placed behind or before the small lens 503 to block light 106 from the outside environment. A notch filter 504 is placed on the outer region 502 of the contact lens 501 to block light 105 coming from the display and allow light 106 from the outside environment to be transmitted.

In another design, a polarization filter 505 is placed behind or before the small lens 503 to block light 106 from the outside environment. A polarization filter 504, with polarization orthogonal to the filter 505 placed behind or before the small lens 503, is placed on the outer region 502 of the contact lens 501 to block light 105 coming from the display and allow light 106 from the outside environment to be transmitted.

The eye 110 can then focus simultaneously light 105 and 106 from the display and the outside environment respectively, onto the retina.

### Device Fabrication

Commercially available MLAs are typically provided on flat substrates. In at least one embodiment, MLA 601 can be replicated on curved surfaces 603, e.g. either cylindrical or spherical surfaces, with the process shown in FIG. 6. A negative replica 602 of the MLA 601 is replicated in, but not limited to, an elastomer. A drop of, but not limited to, curable polymer 604 is then dispensed on the concave side of the curved surface 603. The MLA negative replica 602 acts then as a mold. The flexibility of the elastomer enables the negative replica 602 to conform to the curved surface 603. After UV curing, the mold 602 can be removed yielding a MLA 204 on a curved surface.

Any efficient holographic material can be used to fabricate the holographic screen 114. In order to produce a colour screen, a holographic material presenting a polychromatic sensitivity could be used. For example, the holographic film is sensitive to red, green and blue light. It is then possible to obtain holographic screens diffracting efficiently at several wavelengths by recording either sequentially or simultaneously the hologram with different wavelengths. Another method is to record each holographic film with one wavelength and subsequently place the films on top of each other. In this last case, different holographic materials with different spectral sensitivity could be used.

A holographic film can be laminated onto transparent substrates having either flat or cylindrical surfaces. In the case of spherical surfaces, a liquid photopolymer is necessary as a flat sheet is not compliant onto such surface.

It is preferable to place the holographic film 111 in close proximity to the MLA 204 during the holographic recording such that multiple interferences from different lenslets 205 are avoided at the holographic film 111 plan. To achieve this, for the case of a curved screen, the radius of curvature of the holographic screen needs to be similar to the radius of curvature of the replicated MLA 204.

In order to obtain the optimal diffraction efficiency, the intensity of the reference 201 and object 202 beams, on the holographic film 111, should be nearly equal to generate high interference fringes contrast.

### Proof of Principle Demonstration and Measurements

As a proof of principle, colour holographic screens have been fabricated on cylindrical surfaces using the setup illustrated in FIG. 7. A red 643 nm laser diode, green 532 nm DPSS laser and blue 458 nm Argon laser are used to record colour holograms. The red and green beams are combined with the dichroic mirror DM1 prior being spatially filtered by the microscope objective OBJ1, a single mode optical fibre and a 40 mm collimating lens (L1). In a similar way, the 458 nm beam is spatially filtered by the microscope objective OBJ2, a single mode optical fibre and a 40 mm collimating lens (L2). Red, green and blue beams are combined with the dichroic mirror DM2. Each beam can be controlled with shutters separately. The polarizing beam splitter PBS splits the incoming beam light into reference and object beams. The intensity ratio between object and reference beam and intensity ratio between wavelengths can be adjusted using the half wave plates HWP1, HWP2 and HWP3 and modifying the coupling inside the optical fibres. Both object and reference beams are expanded by lenses L3, L4, L6 and L7. The reference beam is transmitted through the lens L5 before it is incident on the centre of the holographic film at an angle of 45° with a numerical aperture of 0.3 so as to mimic the illumination conditions of a laser projection system (picoprojector) mounted on the side of the eyewear. The object beam is transmitted through a 60 mm focal length condenser lens L8 and the MLA replicated on a curved surface.

The holographic film used is a BAYFOL® HX photopolymer provided by Bayer. The film consists of a 16 μm thick photopolymer with polychromatic sensitivity sandwiched in between a 40 μm thick protective cover film and a 175 μm thick substrate. The photopolymer surface was then laminated on the convex side of a 2.5 mm thick cylindrical surface cut from a DURAN® tube having an outer radius of curvature similar to the radius of curvature described by the position of the top of each lenses within the MLA.

FIG. 8 illustrates the setup to demonstrate the capabilities of the fabricated hologram to act as a transflective screen. A SHOWWX+™ Laser Pico Projector from MicroVision is used to display information on the holographic screen. As the commercial projector provides sharp images from 500 mm onwards, a 50 mm focal length lens is placed at the output of the projector to obtain an image size on the holographic screen corresponding to the field of view of our imaging system. A 1/2.5″ board CMOS colour camera together with a 7.5 mm focal length Sunex camera lens is used as an artificial eye. This camera system provides a 55° field of view.

A contact lens (as described above) is placed in front of the camera lens. At its centre, the contact lens has a 1 mm diameter lens of focal length 29 mm. The central part of the contact lens collimates the light coming from the holographic screen placed at 29 mm from the contact lens while light transmitted by the outer part remains unaltered. A polarizer is placed at the centre of the contact lens to allow only the polarized light from the projector to be transmitted at the centre of the lens. A polarizer oriented perpendicular to the polarizer placed at the centre of the contact lens blocks display light on the outer part of the contact lens. This is illustrated in FIGS. 8(b) and 8(c) where the contact lens is imaged under linearly polarized light for two different angle of rotation. Light is blocked and transmitted respectively by the central and outer part of the contact lens in FIG. 8(b), while the reverse is observed on rotating the contact lens by 90° in FIG. 8(c).

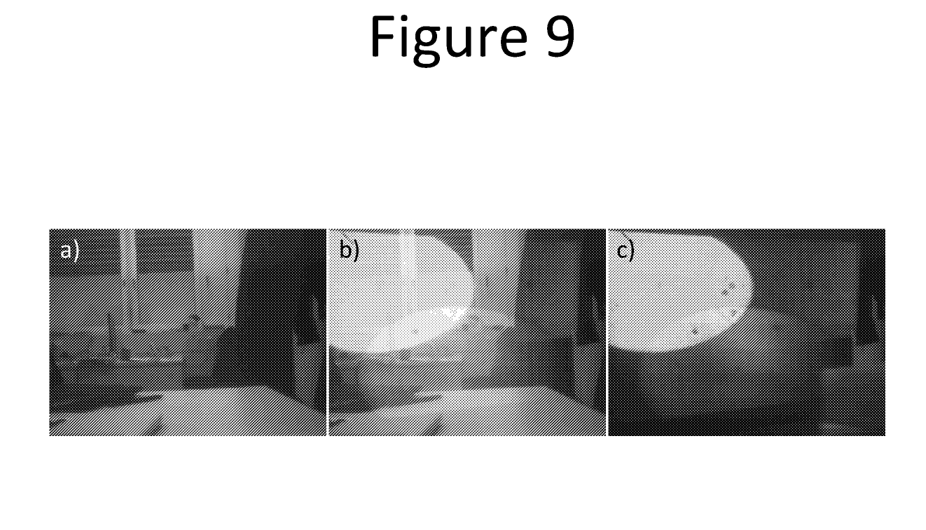

FIG. 9 shows images taken from the display system. FIG. 9a) is taken without any projected image on the holographic screen, showing that there is virtually no parasitic effect in the see-through vision. FIG. 9b) is obtained with an image projected on the holographic screen. It can be seen that both the see-through vision and added information are both in focus. FIG. 9c) is obtained with an image projected on the holographic screen and the see-through vision is partially blocked. Large contrast, good brightness homogeneity and vision over the 55° field of view of the imaging system are observed.

1. A display panel assembly comprising
a transflective holographic screen, i.e., a transparent screen that reflects light
from a projection system, comprising at least
a volume hologram,
a first protective element and a second protective element each arranged in contact with the volume hologram such that the volume hologram is sandwiched between the first protective element and the second protective element,
a projection system focusing an image on the volume hologram comprising at least projection optics,
mounting means arranged to fixedly mount the projection system relatively to the transflective holographic screen,
the volume hologram comprising a plurality of diffractive patterns disposed in sequence across the volume hologram, each of the plurality of diffractive patterns being configured to diffuse the light rays from the projection system in a determined direction corresponding to the specific diffractive pattern and oriented towards a position of an intended eye of a user wearing the display panel assembly.

2. The display panel assembly of claim 1, wherein the display panel assembly is used as a Head-Up Display (HUD).

3. The display panel assembly of claim 1, wherein the display panel assembly is further arranged to be used as a near to the eye Head-Worn Display (HWD).

4. The display panel assembly of claim 1, further comprising
a bi-focal contact lens comprising
a centre part which is arranged relative to the transflective holographic screen to collimate the light diffracted by the volume hologram prior entering the intended eye of the user thereby enabling the intended eye of the user to focus onto the transflective holographic screen, and
an outerpart, which surrounds the centre part and is intended to allow an image of a view through the transflective holographic screen to be seen.

5. The display panel assembly of claim 1, wherein the projection system is a scanner projection system that is used to display information on the transflective holographic screen.

6. A method for fabricating the volume hologram of the display panel assembly of claim 1, the method comprising
interfering a reference beam and an object light beam on the photosensitive holographic material, the light beams having similar wavelengths than the light used within the projection system of the display panel, by means of a recording holographic setup, comprising
directing the reference beam to impinge on the photosensitive holographic material with the properties of the projection system, i.e., whereby the properties are indicative at which angle of incidence and with which numerical aperture the reference beam is projected on the photosensitive holographic material,
directing the object beam to impinge on an opposite side of the photosensitive holographic material as compared to the reference beam thereby producing a reflection hologram.

7. The method of claim 6 further comprising
providing the photosensitive holographic material as a film laminated onto a transparent substrate.

8. The method of claim 6 further comprising
providing the photosensitive holographic material as a liquid photopolymer by coating any surface shape in contact with the photosensitive holographic material.

9. The method of claim 8 further comprising
shaping the any surface in contact with the photosensitive holographic material according to one of the following list of shapes: flat, cylindrical, spherical.

10. The method of claim 6, further comprising
recording the volume hologram either simultaneously or sequentially with several wavelengths to produce a colour screen.

11. The method of claim 6, further comprising
transmitting the object beam through a structure that diffuses light within a given angular spread so that upon use, the then obtained volume hologram enabling the transflective holographic screen to direct the projected light toward the intended eye of the user within a certain angular spread.

12. The method of claim 11 further comprising
providing for the structure that diffuses light a microlens array (MLA) whose lenses' numerical aperture defines an angular spread of each pixel and a pitch of the microlens array defines a minimum pixel size of the screen.

13. The method of claim 12, wherein a fill factor of the microlens arrays (MLA) is larger than 90%.

14. The method of claim 12, further comprising
replicating the microlens array (MLA) on a curved surface with at least the following fabrication steps:
replicating a negative replica of the microlens array (MLA) in, but not limited to, an elastomer,
dispensing a drop of, but not limited to, curable polymer on a concave side of the curved surface,
whereby the microlens array (MLA) negative replica acts as a mold and a flexibility of the elastomer enables the negative replica to conform to the curved surface,
curing the polymer with a UV curing treatment,
removing the mold to release the microlens array (MLA) on a curved surface.

15. The method of claim 12, further comprising using a condenser lens in combination to the structure that diffuses light such that light is directed toward the intended eye of the user, thus increasing the field of view and tolerance to rotation of the eye.
